(19) United States
(12) Patent Application Publication
(10) Pub. No.: US 2011/0316661 A1
(43) Pub. Date: Dec. 29, 2011

(54) UNSATURATED POLYESTER RESIN COMPOSITION FOR COIL ADHESION

(76) Inventors: Takahito MURAKI, Hitachinaka (JP); Satoru Amou, Hitachi (JP); Tomio Iwasaki, Tsukuba (JP)

(21) Appl. No.: 13/167,147

(22) Filed: Jun. 23, 2011

(30) Foreign Application Priority Data
Jun. 25, 2010 (JP) 2010-144392

(51) Int. Cl. H01F 17/04; C09J 133/04; C09J 131/02; C09J 4/00

(52) U.S. Cl. 336/221; 525/125; 525/126

(57) ABSTRACT

It is an objective of the present invention to provide a highly adhesive unsaturated polyester resin composition for fixing or immobilizing coils. There is provided an unsaturated polyester resin composition for adhesion of a coil, which includes the ingredients of: A) an unsaturated polyester resin and/or a vinyl ester resin; B) a monomer including a vinyl group as a polymerizable substituent at at least one end thereof; C) an isocyanate; and D) a polymerization initiator.

### CLAIM OF PRIORITY

The present application claims priority from Japanese patent application serial no. 2010-144392 filed on Jun. 25, 2010, the content of which is hereby incorporated by reference into this application.

### BACKGROUND OF THE INVENTION

1. Field of the Invention

The present invention relates to highly adhesive unsaturated polyester resin compositions, and particularly to unsaturated polyester resin compositions suitable for electrical insulation and immobilization of electrical equipment such as motors and transformers.

2. Description of Related Art

Coils for use in electrical equipment such as motors and transformers are fixed and immobilized using thermosetting resin compositions for purposes such as electrical insulation, heat dissipation, absorption of noises caused by electric oscillations, and integration of components. Unsaturated polyester resins and epoxy resins are widely used as such thermosetting resin compositions. In particular, unsaturated polyester resins are more widely used because of their well-balanced properties such as excellent thermosetting properties, good tack free properties, excellent adhesion properties, good electrical insulation, and low cost.

Because of the recent demand for smaller and higher performance electrical equipment, coils for use in such electrical equipment need to be wound more densely and faster. In order to withstand such severe winding processes, there is growing use of self-lubricating enameled wires containing a lubricant ingredient in an outer surface region thereof. However, most of conventional unsaturated polyester resins do not sufficiently adhere to such self-lubricating enameled wires.

Attempts have been made in order to address the above problem. JP-A 2005-187780 discloses a lining composition containing an unsaturated polyester resin, in which an isocyanate group-containing compound is added to the lining composition. However, the lining composition of the above JP-A 2005-187780 contains a polyisocyanate, therefore possibly shortening the pot life.

JP-A 2005-285791 discloses a resin composition containing a diacrylate derivative of a polyalkylene oxide. However, this resin composition may possibly undergo thermal weight loss, and thus may suffer from resin contraction or resin deficiency by heat during use.

### SUMMARY OF THE INVENTION

In view of the foregoing, it is an objective of the present invention to solve the above problems and to provide a highly adhesive unsaturated polyester resin composition for fixing or immobilizing coils.

According to one aspect of the present invention, there is provided an unsaturated polyester resin composition for adhesion of a coil, which includes the ingredients of: A) an unsaturated polyester resin and/or a vinyl ester resin; B) a monomer including a vinyl group as a polymerizable substituent at least one end thereof; C) an isocyanate; and D) a polymerization initiator.

In the above aspect of the invention, the following modifications and changes can be made.

i) The ingredient C includes at least one polymerizable carbon-carbon double bond.

ii) The ingredient C includes a vinyl group at least one end thereof.

iii) The ingredient C is an isocyanate derivative exhibiting a thermal latency.

iv) The ingredient D is selected from the group consisting of organic peroxides, alkylboranes, and mixtures thereof.

v) The unsaturated polyester resin composition has a nonvolatile content of 90% or more.

vi) There is provided a coil for use in an electrical equipment including: a magnetic core; a wire wound around the core; and the unsaturated polyester resin composition described above, the core and the wire being covered with the unsaturated polyester resin composition for electrical insulation.

vii) There is provided an electrical apparatus including the above coil.

### ADVANTAGES OF THE INVENTION

According to the present invention, it is possible to provide a highly adhesive unsaturated polyester resin composition for fixing or immobilizing coils.

### BRIEF DESCRIPTION OF THE DRAWINGS

FIG. 1 is a schematic illustration showing a coil for use in an electrical apparatus, which is electrically insulated by using a thermosetting resin composition according to the present invention.

FIG. 2 is a schematic illustration showing a construction of an electric rotary machine.

### DETAILED DESCRIPTION OF THE PREFERRED EMBODIMENTS

The inventors have found that the hereby-described invented resin composition has excellent adhesion, through vigorous research. Preferred embodiments of the present invention will be described hereinafter with reference to the accompanying drawings. It should be noted that the present invention is not limited to the embodiments described here, and appropriate combinations and modifications can be implemented without changing the gist of the invention.

As shown before, the resin composition of the invention includes as ingredients: A) an unsaturated polyester resin and/or a vinyl ester resin; B) a monomer having a vinyl group as a polymerizable substituent at least one end thereof; C) an isocyanate; and D) a polymerization initiator. These ingredients A to D will be described in detail below.

(Ingredient A)

The unsaturated polyester resin and vinyl ester resin used as the ingredient A are a compound having a molecular weight of preferably 450 or more, more preferably from 450 to 5000. The unsaturated polyester resin used as the ingredient A is not particularly limited, but can be formed, for example, by condensation reaction of a dibasic acid and a polyhydric alcohol.

Examples of dibasic acids used to produce the unsaturated polyester resin in the ingredient A include, but are not limited to: α,β-unsaturated dibasic acids (such as maleic acid, maleic anhydride, fumaric acid, itaconic acid, and itaconic anhydride); and saturated dibasic acids (such as phthalic acid, phthalic anhydride, halogenated phthalic anhydrides, isophthalic acid, terephthalic acid, tetrahydrophthalic acid, tetrahydrophthalic anhydride, hexahydrophthalic acid, hexahydroisophthalic acid, hexahydroterephthalic acid, cyclopentadiene-maleic anhydride adducts, succinic acid, malonic acid, glutaric acid, adipic acid, sebacic acid, 1,10-decanedicarboxylic acid, 2,6-naphthalenedicarboxylic acid, 2,7-naphthalenedicarboxylic acid, 2,3-naphthalenedicarboxylic acid, 2,3-naphthalenedicarboxylic anhydride, 4,4′-biphenyldicarboxylic acid, and dialkyl esters of these acids). These dibasic acids may be used alone or in admixture of two or more.

Examples of polyhydric alcohols used to produce the unsaturated polyester resin in the ingredient A include, but are not limited to: ethylene glycols (such as ethylene glycol, diethylene glycol, and polyethylene glycols); propylene glycols (such as propylene glycol, dipropylene glycol, and polypropylene glycols); 2-methyl-1,3-propanediol; 1,3-butanediol; adducts of bisphenol A and propylene oxide (or ethylene oxide); glycerin; trimethylolpropane; 1,3-propanediol; 1,2-cyclohexane glycol; 1,3-cyclohexane glycol; 1,4-cyclohexane glycol; para-xylene glycol; bicyclohexyl-4,4′-diol; 2,6-decalin glycol; and tris(2-hydroxyethyl)isocyanurate. Amino alcohols such as ethanolamines may also be used as the polyhydric alcohol. The above-cited polyhydric alcohols may be used alone or in admixture of two or more, and, as needed, may be modified by addition of an epoxy resin, a diisocyanate, dicyclopentadiene, or the like.

The vinyl ester resin in the ingredient A is not particularly limited so long as it is formed, for example, by reaction of an epoxy compound and an unsaturated monobasic acid in the presence of an esterification catalyst.

The epoxy compound used to produce the vinyl ester resin in the ingredient A has at least two epoxy groups. Examples of such epoxy compounds include, but are not limited to: epibis-type glycidyl ether epoxy resins formed by condensation reaction of a bisphenol (such as bisphenol A) with an epihalohydrin; and glycidyl ether epoxy resins formed by condensation reaction of 4,4′-biphenol, a hydrogenated bisphenol, or a glycol with an epihalohydrin. These epoxy compounds may be used alone or in admixture of two or more.

The unsaturated monobasic acid to produce the vinyl ester resin in the ingredient A is not particularly limited, but is, for example, acrylic acid, methacrylic acid, or crotonic acid. These unsaturated monobasic acids may be used alone or in admixture of two or more.

(Ingredient B)

As described, the ingredient B is a monomer having a vinyl group as a polymerizable substituent at least one end thereof. Examples of such monomers include: styrene, vinyl toluene, α-methyl styrene, (meth)acrylic esters, vinyl acetate, diallyl phthalate, and trimethylolpropane tri(meth)acrylate. These monomers may be modified by addition of ethylene oxide, propylene oxide, or the like depending on the application or requirement. Of the above monomers, styrene, vinyl toluene, and (meth)acrylic esters (such as methacrylates and acrylates) are particularly preferable. The above-cited monomers may be used alone or in admixture of two or more.

Examples of (meth)acrylic esters include: methyl (meth)acrylate, ethyl (meth)acrylate, propyl (meth)acrylate, butyl (meth)acrylate, 2-ethylhexyl (meth)acrylate, isooctyl (meth)acrylate, isodecyl (meth)acrylate, phenyl (meth)acrylate, cyclohexyl (meth)acrylate, dicyclopentanyl (meth)acrylate, dicyclopentenyl (meth)acrylate, isobornyl (meth)acrylate, methoxylated cyclotriene (meth)acrylate, dicyclopentenyloxyethyl (meth)acrylate, 2-hydroxyethyl (meth)acrylate, 2-hydroxypropyl (meth)acrylate, 3-hydroxypropyl (meth)acrylate, 4-hydroxybutyl (meth)acrylate, polyethylene glycol (meth)acrylate, alkyloxypolypropylene glycol (meth)acrylate, tetrahydrofurfuryl (meth)acrylate, 2-hydroxy-3-phenoxypropyl (meth)acrylate, glycidyl (meth)acrylate, caprolactone-modified tetrafurfuryl (meth)acrylate, ethoxycarbonylmethyl (meth)acrylate, phenol ethylene oxide-modified acrylate, para-cumylphenol ethylene oxide-modified acrylate, nonylphenol ethylene oxide-modified acrylate, nonylphenol polypropylene oxide-modified acrylate, 2-ethylhexyl carbitol acrylate, 1,4-butanediol (meth)acrylate, acrylonitrile butadiene methacrylate, and dicyclopentenyloxyethyl methacrylate.

Mass ratio of the ingredient A to the ingredient B, (A)/(B), is preferably from 10/90 to 80/20, and more preferably from 10/90 to 60/40. When the mass ratio of the ingredient A is more than 80, the viscosity of the resulting resin will increase. As a result, it becomes difficult to smoothly apply the resulting resin composition around, e.g., a coil and uniformly impregnate the coil with the resin composition, i.e., causing poor processability. On the other hand, when the mass ratio of the ingredient A is less than 10, the thermosetting properties and thermal resistance of the resulting resin composition will degrade.

(Ingredient C)

The isocyanate used as the ingredient C is not particularly limited, but is preferably a compound having at least one polymerizable carbon-carbon double bond, and more preferably a compound having a vinyl group at least one end thereof.

Examples of such isocyanates include: octadecyl isocyanate, 2-methacryloyloxyethyl isocyanate, 2-methacryloyloxyethoxyethyl isocyanate, 2-acryloyloxyethyl isocyanate, 1,1-bis(acryloyloxymethyl)ethyl isocyanate, diphenylmethane diisocyanate, hexamethylene diisocyanate, biurets of hexamethylene diisocyanate, hexamethylene-diisocyanate cyclic trimer, compounds formed by reaction of 1 mole of a polyhydric alcohol having n hydroxy groups (such as trimethylolpropane and glycerin) with n moles of a diisocyanate, isocyanate derivatives exhibiting a thermal latency in which one or more isocyanate groups are blocked (such as 2-(O-[1′-methylpropylideneamino]carboxyamino) ethyl methacrylate and 2-[(3,5-dimethylpyrazolyl) carboxyamino]ethyl methacrylate. The term thermal latency, as used herein, means that an isocyanate group(s) is/are formed by removing a blocking group(s) by heating to 50° C. or higher. Other examples of isocyanates usable as the ingredient C include isocyanates (having a vinyl group at at least one end thereof) formed by reaction of a vinyl compound having a hydroxy or amino group (such as allyl alcohol, allylamine, and 2-hydroxyethyl (meth)acrylate) with an isocyanate such as polyisocyanates (such as diphenylmethane diisocyanate, hexamethylene diisocyanate, biurets of hexamethylene diisocyanate, and hexamethylene-diisocyanate cyclic trimer).

Of the above-cited isocyanates, particularly preferable are: isocyanates having a vinyl group at least one end thereof and only one isocyanate at an end thereof (such as 2-methacryloyloxyethyl isocyanate); and 2-[(3,5-dimethylpyrazolyl) carboxyamino]ethyl methacrylate where isocyanates have a thermal latency, because use of these isocyanates does not shorten the pot life of the resulting resin composition and improve the adhesion strength. On the other hand, use of polyisocyanates shortens the pot life of the resulting resin composition although it improves the adhesion strength. These vinyl-group-containing isocyanates and vinyl-group-containing isocyanates having a thermal latency are commercially readily available (e.g., Karenz MOI and Karenz MOI-BP available from Showa Denko Inc.)

Parts by mass of the ingredient C to 100 parts by mass of the sum of ingredients A and B is preferably from 0.1 to 20, and more preferably from 0.5 to 10. Parts by mass less than 0.1 of the ingredient C will provide almost no improvement in the adhesion of the resulting resin composition. On the other hand, parts by mass more than 20 of the ingredient C will generate foams in the resulting resin composition and therefore degrade the adhesion.

(Ingredient D)

The polymerization initiator used as the ingredient D should include at least one material selected from organic peroxides and alkylboranes.

Examples of organic peroxides usable for the ingredient D include, but are not limited to: benzoyl peroxide, lauroyl peroxide, tertiary butyl peroxybenzoate, tertiary amyl peroxybenzoate, tertiary amyl peroxyneodecanoate, tertiary butyl peroxyneodecanoate, tertiary amyl peroxyisobutyrate, di-tertiary-butyl peroxide, dicumyl peroxide, cumene hydroperoxide, 1,1-di(tertiary butyl peroxy)cyclohexane, 2,2-di(tertiary butyl peroxy)butane, and tertiary butyl hydroperoxide. These organic peroxides may be used alone or in admixture of two or more.

Examples of alkylboranes usable for the ingredient D include boron compounds expressed by the chemical formula (1) below.

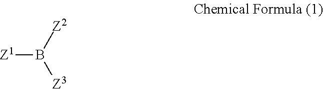

where Z¹, Z² and Z³ are independently R¹ or O—R¹, but at least one of Z¹, Z² and Z³ is R¹ (where R¹ is a hydrogen atom, or an alkyl, cycloalkyl, aralkyl or aryl group; and O is an oxygen atom). The above-cited polymerization initiators may be used alone or in admixture of two or more.

Mass ratio of the polymerization initiator used as the ingredient D to the total of the ingredients A, B and C is preferably from 0.2 to 5.0 mass %. When the mass ratio is less than 0.2 mass %, the resulting resin composition cannot be cured sufficiently, and thus does not exhibit desired properties. On the other hand, the mass ratios more than 5.0 mass % will undesirably shorten the pot life of the resulting resin composition.

(Other Optional Ingredients)

As needed, other optional ingredients may be added to the invented thermosetting resin composition. For example, a curing accelerator may be added to improve the curing properties of the resulting resin composition. Examples of curing accelerators include naphthenates and octoates of a metal (such as cobalt, zinc, zirconium, manganese and calcium). These curing accelerators may be used alone or in admixture of two or more.

As needed, a coupling agent may be added to improve the adhesion of the resulting resin composition. Examples of coupling agents include vinyl trimethoxysilane and styryltriethoxysilane. These coupling agents may be used alone or in admixture of two or more.

As needed, a polymerization inhibitor may be added. Examples of polymerization inhibitors include quinones such as hydroquinone, para-tertiarybutylcatechol and pyrogallol. These coupling agents may be used alone or in admixture of two or more.

(Method for Preparation of Invented Composition)

Method for preparation of the invented thermosetting resin composition will be described below. First, the ingredient A of an unsaturated polyester resin and/or a vinyl ester resin, the ingredient B of a monomer having a vinyl group as a polymerizable substituent at least one end thereof, the ingredient C of an isocyanate, and, if needed, an optional ingredient (ingredients) are mixed together and stirred for uniformity at room temperature (25° C.) or while heating. In the case of heating, the heating temperature preferably ranges from 40 to 80° C. depending on the properties (such as viscosity and melting point) of the ingredients A, B and C. As needed, an agitator may be used for the mixing and stirring.

Next, the ingredient D is added to the thus prepared mixture of the ingredients A, B and C, which are then mixed together uniformly at room temperature (25° C.). Thereby, the invented thermosetting resin composition is completed.

The invented thermosetting resin composition can be used for, for example, electrical insulation and fixation of electrical devices (such as motor coils). When the invented thermosetting resin composition is used for, for example, a motor coil of an electrical device, the motor coil is impregnated with the invented resin composition. The impregnation can be performed by any conventionally used technique such as dipping and dripping. The invented thermosetting resin composition is preferably cured at 100 to 140° C. for 0.5 to 3 hours. The curing temperature is properly selected based on the purposes.

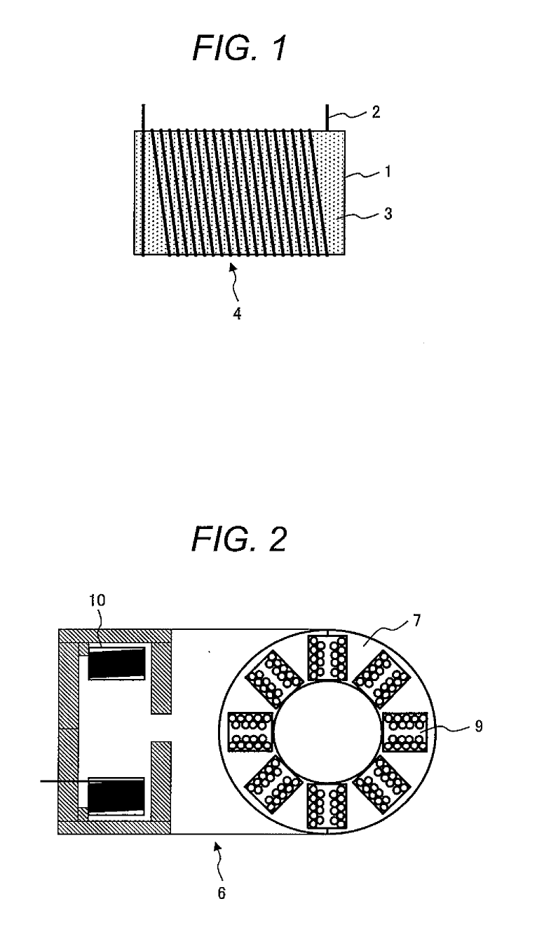

A coil in an electrical apparatus, which is electrically insulated by using the invented thermosetting resin composition, will be described with reference to the accompanying drawings. FIG. 1 is a schematic illustration showing a coil for use in an electrical apparatus, which is electrically insulated by using the invented thermosetting resin composition. FIG. 2 is a schematic illustration showing a construction of an electric rotary machine as an example of electrical apparatuses.

The coil 4 in FIG. 1 is fabricated as follows: First, an enameled wire 2 is wound around a magnetic core 1 made of a metal such as iron. Next, the invented thermosetting resin composition is applied around the core 1 and the wire 2 by dipping, dripping or other methods. Finally, the thus applied invented thermosetting resin composition is cured at an appropriate temperature for an appropriate time to form a curable composition 3. Thus, the coil 4 is electrically insulated by using the invented thermosetting resin composition.

The electric rotary machine 6 in FIG. 2 includes a hollow cylindrical stator 7 and a rotor (not shown) which is coaxially rotatable within the stator 7. The stator 7 and/or the rotor have therein plural axially extending slots 9 and, disposed in the slots 9, plural coils 10 each wound from an enameled wire.

The electric rotary machine 6 is manufactured, for example, as follows: The invented thermosetting resin composition is applied around the stator coils 10 by dipping, dripping or other methods. Next, the thus applied invented thermosetting resin composition is cured at an appropriate temperature for an appropriate time to form an electrically insulated stator. Finally, the stator and the rotor are assembled by a usual procedure. Thus, the stator coils 10 in the electric rotary machine 6 are electrically insulated by using the invented resin composition 3.

### EXAMPLES

The content of the present invention will be described in more detail hereinafter with reference to examples. However, the following examples are given merely as illustrative of the present invention and not to be construed as limiting thereof.

### Preparation of Example 1

First, 55 parts by mass of an unsaturated polyester resin having a number average molecular weight of 3000 and containing isophthalic acid, 45 parts by mass of styrene, and 5.3 parts by mass of hexamethylene-diisocyanate cyclic trimer (Duranate TPA-100 available from Asahi Kasei Chemicals Corporation) were mixed to prepare an unsaturated polyester varnish (a). Then, 1.5 parts by mass of 50 mass % solution of 1,1-di(tertiarybutylperoxy)cyclohexane was added to 100 parts by mass of the varnish (a) to prepare the coil impregnating varnish (i.e., the varnish for impregnating a coil) of Example 1.

And, a helical coil having 5 mm inside diameter and 7.5 cm length was wound from a 1-mm diameter enameled wire (EIW-A, available from Hitachi Magnet Wire Corp.) The helical coil was soaked fully in the coil impregnating varnish of Example 1 for 5 minutes and cured at 120° C. for 1 hour. Further, the thus impregnated helical coil was subjected to the same soak coating in the coil impregnating varnish of Example 1 with upside down and then to curing at 120° C. for 2 hours.

### Preparation of Example 2

First, 10 parts by mass of a dicyclo-type unsaturated polyester resin having a number average molecular weight of 3000, 30 parts by mass of vinyl ester (available from Sigma-Aldrich Co.), 30 parts by mass of dicyclopentenyloxyethyl methacrylate, 30 parts by mass of trimethylolpropane triacrylate, and 1 part by mass of 2-methacryloyl oxyethyl isocyanate (Karenz MOI available from Showa Denko K.K.) were mixed to prepare an unsaturated polyester varnish (b). Then, 2.4 parts by mass of 50 mass % solution of 1,1-di(tertiarybutylperoxy)cyclohexane was added to 100 parts by mass of the varnish (b) to prepare the coil impregnating varnish of Example 2.

And, another helical coil having 5 mm inside diameter and 7.5 cm length was wound from a 1-mm diameter enameled wire (EIW-A, available from Hitachi Magnet Wire Corp.) The helical coil was soaked fully in the coil impregnating varnish of Example 2 for 5 minutes and cured at 120° C. for 0.5 hour. Further, the thus impregnated helical coil was subjected to the same soak coating in the coil impregnating varnish of Example 2 with upside down and then to curing at 120° C. for 0.5 hour.

### Preparation of Example 3

First, 10 parts by mass of a dicyclo-type unsaturated polyester resin having a number average molecular weight of 3000, 30 parts by mass of vinyl ester (available from Sigma-Aldrich Co.), 30 parts by mass of dicyclopentenyloxyethyl methacrylate, 30 parts by mass of trimethylolpropane triacrylate, and 10 parts by mass of 2-methacryloyl oxyethyl isocyanate (Karenz MOI available from Showa Denko K.K.) were mixed to prepare an unsaturated polyester varnish (c). Then, 0.45 part by mass of 50 mass % solution of 1,1-di(tertiarybutylperoxy)cyclohexane and 0.35 part by mass of diethylmethoxyborane were added to 100 parts by mass of the varnish (c) to prepare the coil impregnating varnish of Example 3.

And, another helical coil having 5 mm inside diameter and 7.5 cm length was wound from a 1-mm diameter enameled wire (AIW, available from Hitachi Magnet Wire Corp.) The helical coil was soaked fully in the coil impregnating varnish of Example 3 for 5 minutes and cured at 120° C. for 0.5 hour. Further, the thus impregnated helical coil was subjected to the same soak coating in the coil impregnating varnish of Example 3 with upside down and then to curing at 120° C. for 0.5 hour.

### Preparation of Example 4

First, 10 parts by mass of a dicyclo-type unsaturated polyester resin having a number average molecular weight of 3000, 30 parts by mass of vinyl ester (available from Sigma-Aldrich Co.), 30 parts by mass of dicyclopentenyloxyethyl methacrylate, 30 parts by mass of trimethylolpropane triacrylate, and 5 parts by mass of 2-[(3,5-dimethylpyrazolyl) carboxyamino]ethyl methacrylate (Karenz MOI-BP available from Showa Denko K.K.) were mixed to prepare a unsaturated polyester varnish (d). Then, 0.35 part by mass of diethylmethoxyborane was added to 100 parts by mass of the varnish (d) to prepare the coil impregnating varnish of Example 4.

And, another helical coil having 5 mm inside diameter and 7.5 cm length was wound from a 1-mm diameter enameled wire (EIW-A, available from Hitachi Magnet Wire Corp.) The helical coil was soaked fully in the coil impregnating varnish of Example 4 for 5 minutes and cured at 120° C. for 0.5 hour. Further, the thus impregnated helical coil was subjected to the same soak coating in the coil impregnating varnish of Example 4 with upside down and then to curing at 120° C. for 1 hour.

### Preparation of Comparative Example 1

First, 55 parts by mass of an unsaturated polyester resin having a number average molecular weight of 3000 and containing isophthalic acid, and 45 parts by mass of styrene were mixed to prepare an unsaturated polyester varnish (e). Then, 1.5 parts by mass of 50 mass % solution of 1,1-di(tertiarybutylperoxy)cyclohexane was added to 100 parts by mass of the varnish (e) to prepare the coil impregnating varnish of Comparative example 1.

And, another helical coil having 5 mm inside diameter and 7.5 cm length was wound from a 1-mm diameter enameled wire (EIW-A, available from Hitachi Magnet Wire Corp.) The helical coil was soaked fully in the coil impregnating varnish of Comparative example 1 for 5 minutes and cured at 120° C. for 1 hour. Further, the thus impregnated helical coil was subjected to the same soak coating in the coil impregnating varnish of Comparative example 1 with upside down and then to curing at 120° C. for 2 hours.

### Preparation of Comparative Example 2

First, 10 parts by mass of a dicyclo-type unsaturated polyester resin having a number average molecular weight of 3000, 30 parts by mass of vinyl ester (available from Sigma-Aldrich Co.), 30 parts by mass of dicyclopentenyloxyethyl methacrylate, and 30 parts by mass of trimethylolpropane triacrylate were mixed to prepare an unsaturated polyester varnish (f). Then, 2.4 parts by mass of 50 mass % solution of 1,1-di(tertiarybutylperoxy)cyclohexane was added to 100 parts by mass of the varnish (f) to prepare the coil impregnating varnish of Comparative example 2.

And, another helical coil having 5 mm inside diameter and 7.5 cm length was wound from a 1-mm diameter enameled wire (EIW-A, available from Hitachi Magnet Wire Corp.) The helical coil was soaked fully in the coil impregnating varnish of Comparative example 2 for 5 minutes and cured at 120° C. for 0.5 hour. Further, the thus impregnated helical coil was subjected to the same soak coating in the coil impregnating varnish of Comparative example 2 with upside down and then to curing at 120° C. for 0.5 hour.

### Preparation of Comparative Example 3

To 100 parts by mass of the same unsaturated polyester varnish (f) as prepared in Comparative example 2 were added 0.45 parts by mass of 50 mass % solution of 1,1-di(tertiarybutylperoxy)cyclohexane and 0.35 parts by mass of diethylmethoxyborane to prepare the coil impregnating varnish of Comparative example 3.

And, another helical coil having 5 mm inside diameter and 7.5 cm length was wound from a 1-mm diameter enameled wire (AIW, available from Hitachi Magnet Wire Corp.) The helical coil was soaked fully in the coil impregnating varnish of Comparative example 3 for 5 minutes and cured at 120° C. for 0.5 hour. Further, the thus impregnated helical coil was subjected to the same soak coating in the coil impregnating varnish of Comparative example 3 with upside down and then to curing at 120° C. for 0.5 hour.

### Preparation of Comparative Example 4

To 100 parts by mass of the same unsaturated polyester varnish (f) as prepared in Comparative Example 2 was added 0.35 parts by mass of diethylmethoxyborane to prepare the coil impregnating varnish of Comparative example 4.

And, another helical coil having 5 mm inside diameter and 7.5 cm length was wound from a 1-mm diameter enameled wire (EIW-A, available from Hitachi Magnet Wire Corp.) The helical coil was soaked fully in the coil impregnating varnish of Comparative example 4 for 5 minutes and cured at 120° C. for 0.5 hour. Further, the thus impregnated helical coil was subjected to the same soak coating in the Example 1 coil impregnating varnish of Comparative example 4 with upside down and then to curing at 120° C. for 1 hour.

(Characteristics and Adhesion Strength of Varnish)

The storage elastic modulus of each example varnish was measured on a dynamic viscoelasticity measurement apparatus at a temperature range from 30 to 250° C. The viscosity was measured using a Brookfield viscometer. The nonvolatile content in each example varnish was measured according to JIS C2103 at 105° C. after 3 hours. The helical coil securing or immobilizing strength of each example varnish (i.e., the adhesion strength of each example varnish to the helical coil) was measured according to JIS C2103 at a span of 44 mm. Characteristics of each example varnish and the adhesion strength to the helical coil of each example varnish described above as measured by a bending test were shown in Tables 1 and 2.

TABLE 1
Characteristics and adhesion strength of Examples 1 to 4

| | Example 1 | Example 2 | Example 3 | Example 4 |
|---|---|---|---|---|
| Varnish for | Unsaturated | Unsaturated | Unsaturated | Unsaturated |
| Impregnating | Polyester | Polyester | Polyester | Polyester |
| Coil | Varnish (a) | Varnish (b) | Varnish (c) | Varnish (d) |
| Polymerization | 1,1- | 1,1- | 1,1- | Diethylmethoxyborane |
| Initiator | di(tertiarybutylperoxy) | di(tertiarybutylperoxy) | di(tertiarybutylperoxy) | |
| | cyclohexane | cyclohexane | cyclohexane + | |
| | | | Diethylmethoxyborane | |
| Viscosity | 0.3 | 1.8 | 1.8 | 1.8 |
| (Pa · s, at 25° C.) | | | | |
| Nonvolatile | 45 | 96 | 96 | 96 |
| Content (%) | | | | |
| Adhesion | 124 | 127 | 142 | 180 |
| Strength | | | | |
| (N, at 23° C.) | | | | |

TABLE 2
Characteristics and adhesion strength of Comparative examples 1 to 4

| | Comparative | Comparative | Comparative | Comparative |
|---|---|---|---|---|
| | Example 1 | Example 2 | Example 3 | Example 4 |
| Varnish for | Unsaturated | Unsaturated | Unsaturated | Unsaturated |
| Impregnating | Polyester | Polyester | Polyester | Polyester |
| Coil | Varnish (e) | Varnish (f) | Varnish (f) | Varnish (f) |
| Polymerization | 1,1- | 1,1- | 1,1- | Diethylmethoxyborane |
| Initiator | di(tertiarybutylperoxy) | di(tertiarybutylperoxy) | di(tertiarybutylperoxy) | |
| | cyclohexane | cyclohexane | cyclohexane + | |
| | | | Diethylmethoxyborane | |
| Viscosity | 0.2 | 1.8 | 1.8 | 1.8 |
| (Pa · s, at 25° C.) | | | | |
| Nonvolatile | 50 | 94 | 94 | 94 |
| Content (%) | | | | |
| Adhesion | 103 | 110 | 100 | 110 |
| Strength | | | | |
| (N, at 23° C.) | | | | |

(Bending Test for Coil with Core)

A coil was formed by winding a 1-mm diameter enameled wire around a core. A first sample was prepared by impregnating the coil with the coil impregnating varnish of Example 2 and curing the thus impregnated varnish at 120° C. for 0.5 hours. And, a second sample was prepared in the same way except that the coil impregnating varnish of Comparative example 2 was used. The bending test was carried out for each sample. The adhesion strength of the first sample using the Example 2 varnish was 20 N greater than that of the second sample using the Comparative example 2 varnish.

(Bending Test for Coils in Stator)

There was prepared a stator having plural coils therein, each coil being formed by winding a 1-mm diameter enameled wire around a core. Then, a third sample was prepared by impregnating the stator with the coil impregnating varnish of Example 2 and curing at 120° C. for 0.5 hours. And, a fourth sample was prepared in the same way except that the coil impregnating varnish of Comparative example 2 was used. Next, each vanish-impregnated stator sample was cut or broken, and the coils in the stator sample were removed from the cores.

Finally, the adhesion strengths of the Example 2 varnish to the third sample coils and those of the Comparative example 2 varnish to the fourth sample coils were measured by a bending test. The result was that the adhesion strength of the Example 2 varnish to each coil removed from the stator (each third sample coil) was 5 to 15 N greater than that of the Comparative example 2 varnish to any coil removed from the stator (any fourth sample coil).

Although the invention has been described with respect to the specific embodiments for complete and clear disclosure, the appended claims are not to be thus limited but are to be construed as embodying all modifications and alternative constructions that may occur to one skilled in the art which fairly fall within the basic teaching herein set forth.

What is claimed is:

1. An unsaturated polyester resin composition for adhesion of a coil, the composition comprising the ingredients of:
A) an unsaturated polyester resin and/or a vinyl ester resin;
B) a monomer including a vinyl group as a polymerizable substituent at least one end thereof;
C) an isocyanate; and
D) a polymerization initiator.

2. The unsaturated polyester resin composition according to claim 1, wherein the ingredient C includes at least one polymerizable carbon-carbon double bond.

3. The unsaturated polyester resin composition according to claim 1, wherein the ingredient C includes a vinyl group at least one end thereof.

4. The unsaturated polyester resin composition according to claim 1, wherein the ingredient C is an isocyanate derivative exhibiting a thermal latency.

5. The unsaturated polyester resin composition according to claim 1, wherein the ingredient D is selected from the group consisting of organic peroxides, alkylboranes, and mixtures thereof.

6. The unsaturated polyester resin composition according to claim 1, having a nonvolatile content of 90% or more.

7. A coil for use in an electrical equipment, the coil comprising:
a magnetic core;
a wire wound around the core; and
the unsaturated polyester resin composition according to claim 1, the core and the wire being covered with the unsaturated polyester resin composition for electrical insulation.

8. An electrical apparatus comprising the coil according to claim 7.
